(19) United States
(12) Patent Application Publication
(10) Pub. No.: US 2018/0360089 A1
(43) Pub. Date: Dec. 20, 2018

(54) HERBAL SUPPLEMENT AND METHODS FOR FORMULATING THE SAME

(71) Applicant: Syed H. Khundmiri, Glendale Heights, IL (US)

(72) Inventor: Syed H. Khundmiri, Glendale Heights, IL (US)

(21) Appl. No.: 16/012,539

(22) Filed: Jun. 19, 2018

Related U.S. Application Data
(60) Provisional application No. 62/522,476, filed on Jun. 20, 2017.

(51) Int. Cl. A23L 33/105; A23L 2/06; A23L 19/00; A23L 21/25; C12J 1/00

(52) U.S. Cl. CPC A23L 33/105; A23L 2/06; A23V 2002/00; A23L 21/25; C12J 1/00; A23L 19/07

(57) ABSTRACT

An herbal supplement and a method for formulating the same is described herein. The method includes forming a first mixture by combining one of apple cider vinegar or onion juice and one of ginger or ginseng, extracting a first juice from the first mixture, extracting a second juice from one of a citrus fruit or an onion, forming a second mixture by combining the second juice and one or more garlic cloves, extracting a third juice from the second mixture, forming a third mixture by combining the first juice, the third juice, and one of cinnamon, saffron, cardamom, anis seed, a lime peel, or a lemon peel, incubating the third mixture to form an incubated third mixture, and forming a fourth mixture by combining the incubated third mixture and honey.

### CROSS-REFERENCE TO RELATED APPLICATIONS

This application claims priority to U.S. Provisional Patent Application No. 62/522,476, filed Jun. 20, 2017 and entitled “Method for Formulating an Herbal Supplement,” the entirety of which is incorporated by reference herein.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method for formulating an herbal supplement is described herein. The method includes forming a first mixture by combining one of apple cider vinegar or onion juice and one of ginger or ginseng and extracting a first juice from the first mixture. The method further includes extracting a second juice from one of a citrus fruit or an onion and forming a second mixture by combining the second juice and one or more garlic cloves. The method further includes extracting a third juice from the second mixture and forming a third mixture by combining the first juice, the third juice, and one of cinnamon, saffron, cardamom, anis seed, a lime peel, or a lemon peel and incubating the third mixture to form an incubated third mixture. The method also includes forming a fourth mixture by combining the incubated third mixture and honey.

An herbal supplement is also described herein. In one embodiment, the herbal supplement comprises ginger juice or ginseng juice, garlic juice, a spice, honey, apple cider vinegar or onion juice, and citrus juice or onion juice. The citrus juice may be one of lime juice or lemon juice. The spice may be one of cinnamon, saffron, or cardamom. In another embodiment, the herbal supplement comprises ginger juice or ginseng juice, garlic juice, a citrus peel, honey, apple cider vinegar or onion juice, and citrus juice or onion juice. The citrus peel may be one of a lime peel or a lemon peel. The citrus juice may be one of lime juice or lemon juice. Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 depicts a flowchart of a method for formulating an herbal supplement, according to an example embodiment.

FIG. 2 depicts a flowchart of a method for incubating a mixture to form an incubated mixture, according to an example embodiment.

FIG. 3 depicts a flowchart of a method for cooling an incubated mixture, according to an example embodiment.

FIG. 4 depicts a flowchart of a method for forming a mixture, according to an example embodiment.

FIG. 5 depicts a flowchart of a method for extracting a juice from a mixture, according to an example embodiment.

FIG. 6 depicts a flowchart of a method for forming a mixture, according to an example embodiment.

FIG. 7 depicts a flowchart of a method for extracting a juice from a mixture, according to an example embodiment.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Process for Formulating an Herbal Supplement

A method for formulating an herbal supplement is described herein. The method includes forming a first mixture by combining one of apple cider vinegar or onion juice and one of ginger or ginseng and extracting a first juice from the first mixture. The method further includes extracting a second juice from one of a citrus fruit or an onion and forming a second mixture by combining the second juice and one or more garlic cloves. The method further includes extracting a third juice from the second mixture and forming a third mixture by combining the first juice, the third juice, and one of cinnamon, saffron, cardamom, anis seed, a lime peel, or a lemon peel and incubating the third mixture to form an incubated third mixture. The method also includes forming a fourth mixture by combining the incubated third mixture and honey. The herbal supplement formulated in such a manner comprises an all-natural dietary supplement that can provide various health benefits, while having a pleasing taste.

An herbal supplement is also described herein. In one embodiment, the herbal supplement comprises ginger juice or ginseng juice, garlic juice, a spice, honey, apple cider vinegar or onion juice, and citrus juice or onion juice. The citrus juice may be one of lime juice or lemon juice. The spice may be one of cinnamon, saffron, or cardamom. In another embodiment, the herbal supplement comprises ginger juice or ginseng juice, garlic juice, a citrus peel, honey, apple cider vinegar or onion juice, and citrus juice or onion juice. The citrus peel may be one of a lime peel or a lemon peel. The citrus juice may be one of lime juice or lemon juice. Such an herbal supplement comprises an all-natural dietary supplement that can provide various health benefits, while having a pleasing taste.

In embodiments, an herbal supplement may include ginger juice or ginseng juice, garlic juice, a spice, honey, apple cider vinegar or onion juice, and citrus juice or onion juice. In embodiments, the citrus juice is one of lime juice of lemon juice. In additional embodiments, the spice is one of cinnamon, saffron, or cardamom.

Furthermore, in additional embodiments, an herbal supplement may include ginger juice or ginseng juice, garlic juice, a citrus peel, honey, apple cider vinegar or onion juice, and citrus juice or onion juice. In embodiments, the citrus peel is one of a lime peel or a lemon peel. In additional embodiments, the citrus juice is one of lime juice or lemon juice.

For instance, and as an example, an herbal supplement may be formulated using at least the following ingredients: apple cider vinegar; zingiber officinale (ginger); citrus aurantifolia (lime); alium sativum (garlic); cinnamomum verum (cinnamon); and honey.

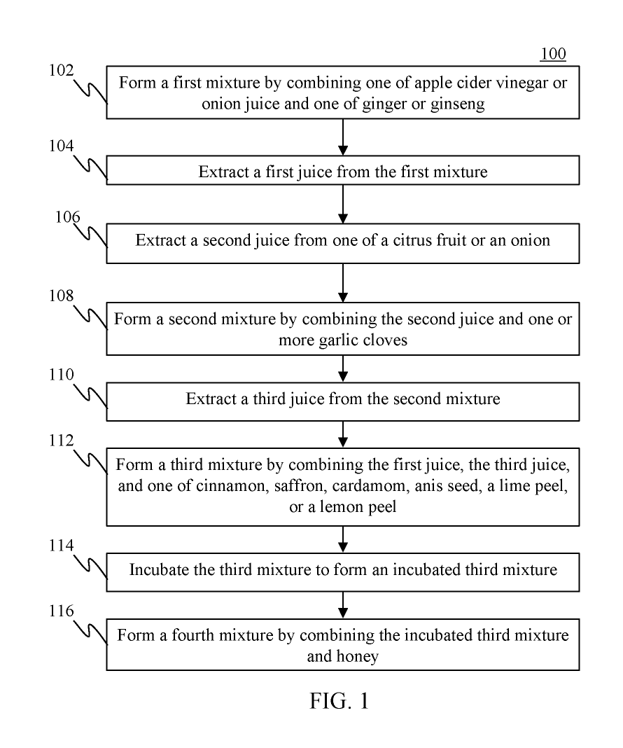

An herbal supplement may be formulated in various ways. For instance, FIG. 1 depicts a flowchart 100 of a method for formulating an herbal supplement, according to an example embodiment. Flowchart 100 is described as follows.

In step 102, a first mixture is formed by combining one of apple cider vinegar or onion juice and one of ginger or ginseng. For example, the first mixture may be formed by combining apple cider vinegar and fresh peeled zingiber officinale. However, as noted above, ginseng may be substituted for the ginger and onion juice may be substituted for the apple cider vinegar. The first mixture may be formed in various ways, described in greater detail hereinafter.

In step 104, a first juice is extracted from the first mixture. For example, following the above example, a first juice including zingiber officinale juice is extracted from the first mixture of apple cider vinegar and fresh peeled zingiber officinale. The first juice may be extracted in various ways, described in greater detail hereinafter.

In step 106, a second juice is extracted from one of a citrus fruit or an onion. In an embodiment, the citrus fruit may be a lime. In another embodiment, the citrus fruit may be a lemon. The second juice may be extracted in various ways. For instance, and in an embodiment, the second juice may be extracted using a manual juice extraction process to obtain a desired juice output. However, this is not intended to be limiting and the second juice may be extracted using any juice extraction method.

In embodiments, any part of the citrus fruit or onion may be used to extract the second juice. For example, one part of the citrus fruit or onion may be used to extract the second juice therefrom. However, this example is not intended to be limiting and any part of the citrus fruit or onion may be used. For example, following the above example, one part citrus aurantifolia is juiced using a manual juice extraction process to obtain maximum juice output. However, as noted above, a lemon or an onion may be substituted for the lime.

In step 108, a second mixture is formed by combining the second juice and one or more garlic cloves. For instance, and following the above example, the citrus autantifolia juice is combined with alium sativum to form a second mixture. The second mixture may be formed in various ways, discussed in greater detail hereinafter.

In step 110, a third juice is extracted from the second mixture. For instance, following the above example, a third juice including alium sativum juice is extracted from the second mixture of citrus aurantifolia juice and alium sativum cloves. The third juice may be extracted in various ways, discussed in greater detail hereinafter.

In step 112, a third mixture is formed by combining the first juice, the third juice, and one of cinnamon, saffron, cardamom, anis seed, a lime peel, or a lemon peel. For example, following the above example, a third mixture is formed by combining the first juice including the zingiber officinale juice, the third juice including the alium sativum juice and cinnamon sticks (making up 2% of the total weight). However, as noted above, saffron, cardamom, anis seed, lime or lemon peel can be substituted for the cinnamon. The third mixture may be formed in various ways, discussed in greater detail hereinafter.

In step 114, the third mixture is incubated to form an incubated third mixture. For example, following the above example, the third mixture of the first juice including the zingiber officinale juice, the third juice including the alium sativum juice, and the cinnamon sticks are incubated to form an incubated third mixture. The third mixture may be incubated in various ways, discussed in detail hereinafter.

In step 116, a fourth mixture is formed by combining the incubated third mixture and honey. The fourth mixture may be formed in various ways. For instance, in an embodiment, the fourth mixture is formed by mixing equal parts of the third mixture and honey. For example, following the above example, equal parts of the incubated mixture of the first juice including the zingiber officinale juice, the third juice including the alium sativum juice, and the cinnamon sticks and honey are mixed together and bottled.

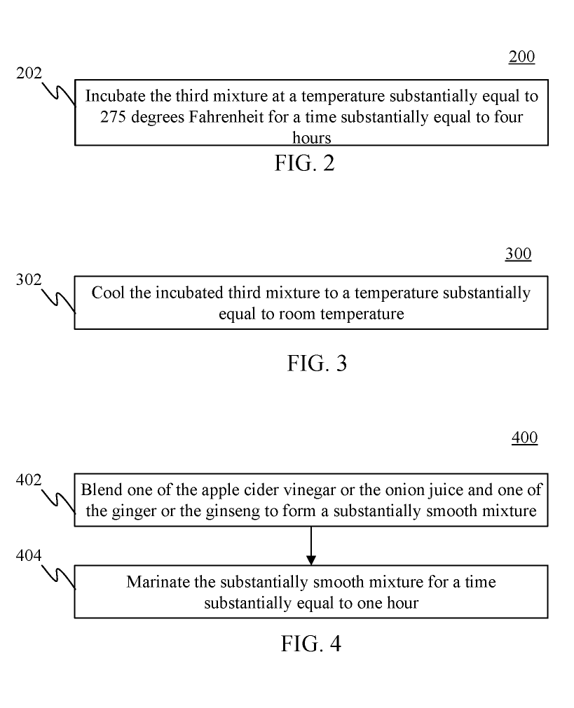

As described above, the third mixture may be incubated in various ways. For instance, FIG. 2 depicts a flowchart 200 of a method for incubating the third mixture to form an incubated third mixture, according to an example embodiment. Flowchart 200 may be implemented as part of step 114 of flowchart 100. Flowchart 200 is described as follows.

In step 202, the third mixture is incubated at a temperature substantially equal to 275 degrees Fahrenheit for a time substantially equal to four hours. In an embodiment, the incubating results in the third mixture being reduced by one-third. For example, following the above example, the third mixture of the first juice including the zingiber officinale juice, the third juice including the alium sativum juice and the cinnamon sticks is incubated at 275 degrees Fahrenheit for four hours such that the third mixture is reduced by one-third. However, this example is not meant to be limiting and the third mixture may be incubated in various ways to form an incubated third mixture.

In embodiments, the method for formulating an herbal supplement may include additional steps. For instance, FIG. 3 depicts a flowchart 300 of a method for cooling the incubated mixture, according to an example embodiment. In an embodiment, flowchart 300 may be implemented after step 114 of flowchart 100 but prior to step 116 of flowchart 100. Flowchart 300 is described as follows.

In step 302, the incubated third mixture is cooled to a temperature substantially equal to room temperature. As used herein, the term “room temperature” refers to a temperature in the range of 64 degrees Fahrenheit to 73 degrees Fahrenheit. For example, following the above example, the incubated third mixture of the first juice including the zingiber officinale juice, the third juice including the alium sativum juice and the cinnamon sticks is cooled to 70 degrees Fahrenheit prior to being combined with the honey. However, this example is not meant to be limiting and the third mixture may be cooled to any temperature within the range of 64 degrees Fahrenheit and 73 degrees Fahrenheit (i.e., “room temperature”).

As noted above, the first mixture may be formed in various ways. For instance, FIG. 4 depicts a flowchart 400 of a method for forming the first mixture, according to an example embodiment. In an embodiment, flowchart 400 may be implemented as part of step 102 of flowchart 100. Flowchart 400 is described as follows.

In step 402, one of the apple cider vinegar or the onion juice and one of the ginger or the ginseng are blended together to form a substantially smooth mixture. In an embodiment, the apple cider vinegar or the onion juice and the ginger or the ginseng are blended together in a food processor. However, this example is not meant to be limiting and the apple cider vinegar or the onion juice and the ginger or ginseng may be blended together in various ways.

In an embodiment, the blending to form the substantially smooth mixture includes blending one part of the apple cider vinegar or the onion juice and one and three-fourths part of the ginger or the ginseng. For example, following the above example, one part apple cider vinegar and one and three-fourths parts of fresh peeled zingiber officinale are blended together in a commercial grade high-performance food processor until a smooth mixture is made.

In step 404, the substantially smooth mixture is marinated for a time substantially equal to one hour. For example, following the above example, the substantially smooth mixture of one part apple cider vinegar and one and three-fourths parts of fresh peeled zingiber officinale is set for one hour to marinate.

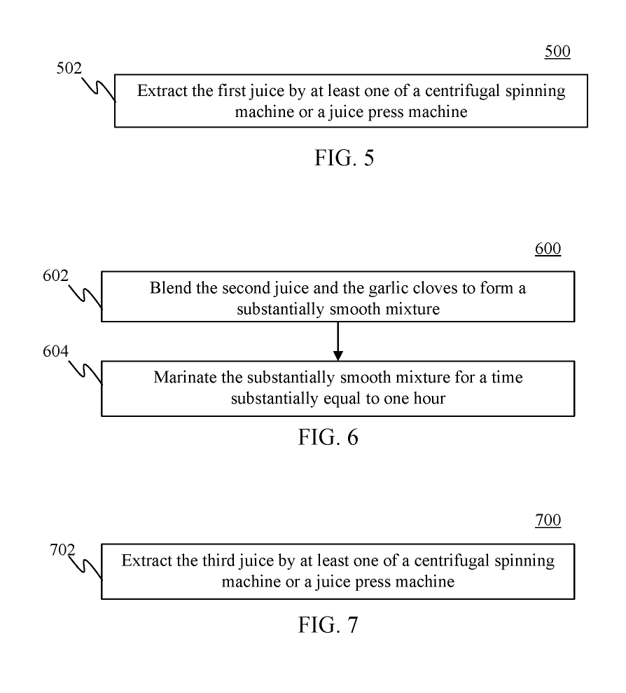

Accordingly, and as noted above with respect to step 104, a first juice is extracted from the formed first mixture. As noted above, this first juice may be extracted in various ways. For instance, FIG. 5 depicts a flowchart 500 of a method for extracting the first juice from the first mixture, according to an example embodiment. In an embodiment, flowchart 500 may be implemented as part of step 104 of flowchart 100. Flowchart 500 is described as follows.

In step 502, the first juice is extracted by at least one of a centrifugal spinning machine or a juice press machine. For instance, and in an embodiment, the first juice is extracted first by a centrifugal spinning machine and then any remaining first juice is extracted by a juice press machine. In another embodiment, the first juice may be extracted only by a centrifugal spinning machine. In yet another embodiment, the first juice may be extracted only by a juice press machine. For example, and following the above example, the first mixture is placed in a commercial grade high speed centrifugal spinning machine to extract the first juice including the zingiber officinale juice and the remaining first juice including the zingiber officinale juice is extracted in a juice press machine. However, this example is not meant to be limiting and the first juice may be extracted from the first mixture by using any juice extraction method, such as but not limited to manual extraction.

As noted above, a second mixture may be formed in various ways. For instance, FIG. 6 depicts a flowchart 600 of a method for forming the second mixture, according to an example embodiment. In an embodiment, flowchart 600 may be implemented as part of step 108 of flowchart 100. Flowchart 600 is described as follows.

In step 602, the second juice and the garlic cloves are blended to form a substantially smooth mixture. For instance, and in an embodiment, the second juice and the garlic cloves are blended together in a food processor. However, this example is not meant to be limiting and the second juice and the garlic cloves may be blended together in various ways.

In an embodiment, the blending to form the substantially smooth mixture includes blending two parts garlic cloves and one part of the second juice. For example, following the above example, one part citrus aurantifolia juice and two parts alium sativum cloves are blended together in a commercial grade high-performance food processor until a smooth mixture is made.

In step 604, the substantially smooth mixture is marinated for a time substantially equal to one hour. For example, following the above example, the substantially smooth mixture of one part citrus aurantifolia juice and two parts alium sativum cloves is set for one hour to marinate.

Accordingly, and as noted above with respect to step 110, a third juice is extracted from the formed second mixture. As noted above, this third juice may be extracted in various ways. For instance, FIG. 7 depicts a flowchart 700 of a method for extracting the third juice from the second mixture, according to an example embodiment. In an embodiment, flowchart 700 may be implemented as part of step 110 of flowchart 100. Flowchart 700 is described as follows.

In step 702, the third juice is extracted by at least one of a centrifugal spinning machine or a juice press machine. For instance, and in an embodiment, the third juice is extracted first by a centrifugal spinning machine and then any remaining third juice is extracted by a juice press machine. In another embodiment, the third juice may be extracted only by a centrifugal spinning machine. In yet another embodiment, the third juice may be extracted only by a juice press machine. For example, the second mixture of citrus aurantifolia juice and alium sativum cloves is placed in a commercial grade high speed centrifugal spinning machine to extract the third juice including the alium sativum juice and the remaining third juice including the alium sativum juice is extracted in a juice press machine. However, this example is not meant to be limiting and the third juice may be extracted from the second mixture by using any juice extraction method such as manual extraction.

### IV. Additional Exemplary Embodiments

A method for formulating an herbal supplement is described herein. The method includes forming a first mixture by combining one of apple cider vinegar or onion juice and one of ginger or ginseng, extracting a first juice from the first mixture, extracting a second juice from one of a citrus fruit or an onion, forming a second mixture by combining the second juice and one or more garlic cloves, extracting a third juice from the second mixture, forming a third mixture by combining the first juice, the third juice, and one of cinnamon, saffron, cardamom, anis seed, a lime peel, or a lemon peel, incubating the third mixture to form an incubated third mixture, and forming a fourth mixture by combining the incubated third mixture and honey.

In an embodiment of the foregoing method, incubating the third mixture to form an incubated third mixture comprises incubating the third mixture at a temperature substantially equal to 275 degrees for a time substantially equal to four hours.

In another embodiment of the foregoing method, the incubating results in the third mixture being reduced by one-third.

In yet another embodiment of the foregoing method, the method further comprises, prior to forming the fourth mixture, cooling the incubated third mixture to a temperature substantially equal to room temperature.

In yet another embodiment of the foregoing method, forming the first mixture comprises blending one of the apple cider vinegar or the onion juice and one of the ginger or the ginseng to form a substantially smooth mixture, and marinating the substantially smooth mixture for a time substantially equal to one hour.

In yet another embodiment of the foregoing method, one of the apple cider vinegar or the onion juice and one of the ginger or the ginseng are blended together in a food processor.

In yet another embodiment of the foregoing method, extracting the first juice from the first mixture comprises extracting the first juice by at least one of a centrifugal spinning machine or a juice press machine.

In yet another embodiment of the foregoing method, the citrus fruit is a lime or a lemon.

In yet another embodiment of the foregoing method, forming the second mixture comprises blending the second juice and the garlic cloves to form a substantially smooth mixture, and marinating the substantially smooth mixture for a time substantially equal to one hour.

In yet another embodiment of the foregoing method, extracting the third juice from the second mixture comprises extracting the third juice by at least one of a centrifugal spinning machine or a juice press machine.

In yet another embodiment of the foregoing method, the blending comprises blending one part of the apple cider vinegar or the onion juice and one and three-fourths part of the ginger or the ginseng.

In yet another embodiment of the foregoing method, the second juice is extracted from one part of either the citrus fruit or the onion.

In yet another embodiment of the foregoing method, the blending comprises blending two parts garlic cloves and one part the second juice.

In yet another embodiment of the foregoing method, forming the fourth mixture comprises combining equal parts of the third mixture and honey.

An herbal supplement is also described herein. The herbal supplement comprises ginger juice or ginseng juice, garlic juice, a spice, honey, apple cider vinegar or onion juice, and citrus juice or onion juice.

In an embodiment of the foregoing herbal supplement, the citrus juice is one of lime juice or lemon juice.

In another embodiment of the foregoing herbal supplement, the spice is one of cinnamon, saffron, or cardamom.

Another herbal supplement is also described herein. The herbal supplement comprises ginger juice or ginseng juice, garlic juice, a citrus peel, honey, apple cider vinegar or onion juice, and citrus juice or onion juice.

In another embodiment of the foregoing herbal supplement, the citrus peel is one of a lime peel or a lemon peel.

In yet another embodiment of the foregoing herbal supplement, the citrus juice is one of lime juice or lemon juice.

### III. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for formulating an herbal supplement, comprising:
forming a first mixture by combining one of apple cider vinegar or onion juice and one of ginger or ginseng;
extracting a first juice from the first mixture;
extracting a second juice from one of a citrus fruit or an onion;
forming a second mixture by combining the second juice and one or more garlic cloves;
extracting a third juice from the second mixture;
forming a third mixture by combining the first juice, the third juice, and one of cinnamon, saffron, cardamom, anis seed, a lime peel, or a lemon peel;
incubating the third mixture to form an incubated third mixture; and
forming a fourth mixture by combining the incubated third mixture and honey.

2. The method of claim 1, wherein incubating the third mixture to form an incubated third mixture comprises:
incubating the third mixture at a temperature substantially equal to 275 degrees for a time substantially equal to four hours.

3. The method of claim 2, wherein the incubating results in the third mixture being reduced by one-third.

4. The method of claim 1, further comprising, prior to forming the fourth mixture:
cooling the incubated third mixture to a temperature substantially equal to room temperature.

5. The method of claim 1, wherein forming the first mixture comprises:
blending one of the apple cider vinegar or the onion juice and one of the ginger or the ginseng to form a substantially smooth mixture; and
marinating the substantially smooth mixture for a time substantially equal to one hour.

6. The method of claim 5, wherein one of the apple cider vinegar or the onion juice and one of the ginger or the ginseng are blended together in a food processor.

7. The method of claim 1, wherein extracting the first juice from the first mixture comprises:
extracting the first juice by at least one of a centrifugal spinning machine or a juice press machine.

8. The method of claim 1, wherein the citrus fruit is a lime or a lemon.

9. The method of claim 1, wherein forming the second mixture comprises:
blending the second juice and the garlic cloves to form a substantially smooth mixture; and
marinating the substantially smooth mixture for a time substantially equal to one hour.

10. The method of claim 1, wherein extracting the third juice from the second mixture comprises:
extracting the third juice by at least one of a centrifugal spinning machine or a juice press machine.

11. The method of claim 5, wherein the blending comprises blending one part of the apple cider vinegar or the onion juice and one and three-fourths part of the ginger or the ginseng.

12. The method of claim 1, wherein the second juice is extracted from one part of either the citrus fruit or the onion.

13. The method of claim 9, wherein the blending comprises blending two parts garlic cloves and one part the second juice.

14. The method of claim 1, wherein forming the fourth mixture comprises combining equal parts of the third mixture and honey.

15. An herbal supplement, comprising:
ginger juice or ginseng juice;
garlic juice;
a spice;
honey;
apple cider vinegar or onion juice; and
citrus juice or onion juice.

16. The herbal supplement of claim 15, wherein the citrus juice is one of lime juice or lemon juice.

17. The herbal supplement of claim 15, wherein the spice is one of cinnamon, saffron, or cardamom.

18. An herbal supplement, comprising:
ginger juice or ginseng juice;
garlic juice;
a citrus peel;
honey;
apple cider vinegar or onion juice; and
citrus juice or onion juice.

19. The herbal supplement of claim 18, wherein the citrus peel is one of a lime peel or a lemon peel.

20. The herbal supplement of claim 18, wherein the citrus juice is one of lime juice or lemon juice.
